(19) United States
(12) Patent Application Publication
(10) Pub. No.: US 2010/0226034 A1
(43) Pub. Date: Sep. 9, 2010

(54) MAGNETIC HEAD, MAGNETIC DISK DEVICE, AND MANUFACTURING METHOD OF MAGNETIC HEAD

(75) Inventor: Goroh KAWASAKI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/718,833

(22) Filed: Mar. 5, 2010

(30) Foreign Application Priority Data
Mar. 5, 2009 (JP) 2009-051755

(51) Int. Cl. G11B 5/02; G11B 5/127

(52) U.S. Cl. 360/59; 29/603.01; G9B/5.026

(57) ABSTRACT

According to one embodiment, a magnetic disk device includes a magnetic disk, a slider opposed to the magnetic disk, and a magnetic head on the slider. The magnetic head includes a head element configured to carry out recording or reproduction, a heating element configured to thermally protrude the element, and a groove configured to partition a peripheral area of the head element in a direction in which the head element are to protrude.

### CROSS-REFERENCE TO RELATED APPLICATIONS

This application is based upon and claims the benefit of priority from Japanese Patent Application No. 2009-051755, filed Mar. 5, 2009, the entire contents of which are incorporated herein by reference.

### BACKGROUND

1. Field

An embodiment of the present invention relates to a magnetic head in which a recording element or reproduction element can be thermally protruded, magnetic disk device provided with the magnetic head, and a method of manufacturing the magnetic head.

2. Description of the Related Art

As a technique associated with a magnetic head in which a recording element or reproduction element can be thermally protruded, there is, for example, one disclosed in Jpn. Pat. Appln. KOKAI Publication No. 2008-123654. A magnetic head disclosed in the above document is provided with an exciting coil serving as a recording element, magneto-resistive effect element serving as a reproduction element, and heating element configured to protrude these elements toward the magnetic disk side.

The magnetic head is provided on an end face of a slider supported on a distal end of a swing arm through a suspension. The slider forms an extremely thin air film between itself and the magnetic disk rotating at high speed. As a result of this, the magnetic head is floated over the magnetic disk in a state where the magnetic head is almost in contact with the surface of the magnetic disk. In the magnetic head which is thus slightly floated over the magnetic disk, a peripheral part of the recording element and reproduction element is thermally expanded by the heat of the heating element, and these elements are protruded toward the magnetic disk side. As a result of this, the flying height of the magnetic head becomes smaller correspondingly by the degree of protrusion of the elements toward the surface of the magnetic disk, thereby realizing further reduction in flying height.

However, in the technique of the magnetic head in which the elements are thermally protruded, the structure is so made that the overall magnetic head including the peripheral part of the elements is uniformly covered with an insulating material, and hence the heat from the heating element is easily transmitted to not only the peripheral part of the elements but also the other parts. This makes it difficult to locally protrude the peripheral part of the elements by thermal expansion.

On the other hand, in order to largely protrude the peripheral part of the elements, it is sufficient if the calorific value is increased to thereby increase the thermal expansion. However, in this case, the thermal load of the elements becomes large, and there is the possibility of the recording/reproduction characteristics of the magnetic head being deteriorated. That is, in the conventional technique, a magnetic head in which the degree of protrusion of the elements can be made large by as small a calorific value as possible has not been realized.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary perspective view showing a magnetic disk device according to an embodiment of the present invention;

FIG. 1B is an exemplary perspective view showing a head part in an enlarging manner;

FIG. 2 is an exemplary perspective view showing a head section of a magnetic head provided in the magnetic disk device in an enlarging manner;

FIG. 3 is an exemplary front view of the head section;

FIGS. 4A, 4B, 4C, 4D, 4E, and 4F are exemplary cross-sectional views of the magnetic head respectively showing manufacturing processes of the magnetic head according to an embodiment of the present invention;

FIGS. 5A, 5B, 5C, 5D, and 5E are exemplary cross-sectional views of the magnetic head respectively showing the manufacturing processes subsequent to FIGS. 4A to 4F;

FIGS. 6A, 6B, 6C, and 6D are exemplary cross-sectional views of the magnetic head respectively showing the manufacturing processes subsequent to FIGS. 5A to 5E;

FIGS. 7A, 7B, 7C, 7D, and 7E are exemplary cross-sectional views of the magnetic head for explaining the respective main parts of the manufacturing processes of the magnetic head;

FIG. 8 is an exemplary graph showing a result of simulation of a degree of protrusion of the peripheral part of the elements for a depth of the groove of the magnetic head;

FIG. 9 is an exemplary perspective view showing a magnetic head according to another embodiment of the present invention;

FIG. 10 is an exemplary front view of the magnetic head according another embodiment;

FIG. 11 is an exemplary perspective view showing a magnetic head according to still another embodiment of the present invention;

FIG. 12 is an exemplary front view of the magnetic head according to still another embodiment;

FIG. 13 is an exemplary perspective view of the magnetic head showing the manufacturing method of the magnetic head according to another embodiment of the present invention; and

FIG. 14 is an exemplary perspective view of the magnetic head showing the manufacturing method of the magnetic head according to another embodiment of the present invention.

### DETAILED DESCRIPTION

Various embodiments according to the invention will be described hereinafter with reference to the accompanying drawings. In general, according to one embodiment of the invention, a magnetic head comprises a head element configured to carry out recording or reproduction, a heating element configured to thermally protrude the head element to make the head element closer to an surface of the magnetic disk, and a groove configured to partition a peripheral area of the head element in a direction in which the head element is to protrude.

According to another aspect of the invention, a method of manufacturing a magnetic head comprises forming, on a slider, a reproduction element configured to carry out reproduction, a recording element configured to carry out recording, and a heating element configured to heat a peripheral area of the reproduction element and recording element including the reproduction element and recording element; and forming grooves configured to partition the peripheral area.

According to the technique disclosed in an embodiment, a magnetic head with a structure in which a peripheral area of the head element is partitioned by grooves in a direction in which the peripheral area of the element is to be thermally protruded is realized. In such a magnetic head, the heat transmitted from the heating element to the peripheral area of the elements is blocked by the grooves to a certain degree, whereby the heat is concentrated at the peripheral area, and it becomes hard for the heat to be transmitted to the outside. As a result of this, it becomes easy for the peripheral area to locally effect thermal expansion, and hence it is possible to make the degree of protrusion of the peripheral area including the elements large by as small a calorific value as possible.

Embodiments of the present invention will be described below in detail with reference to the accompanying drawings.

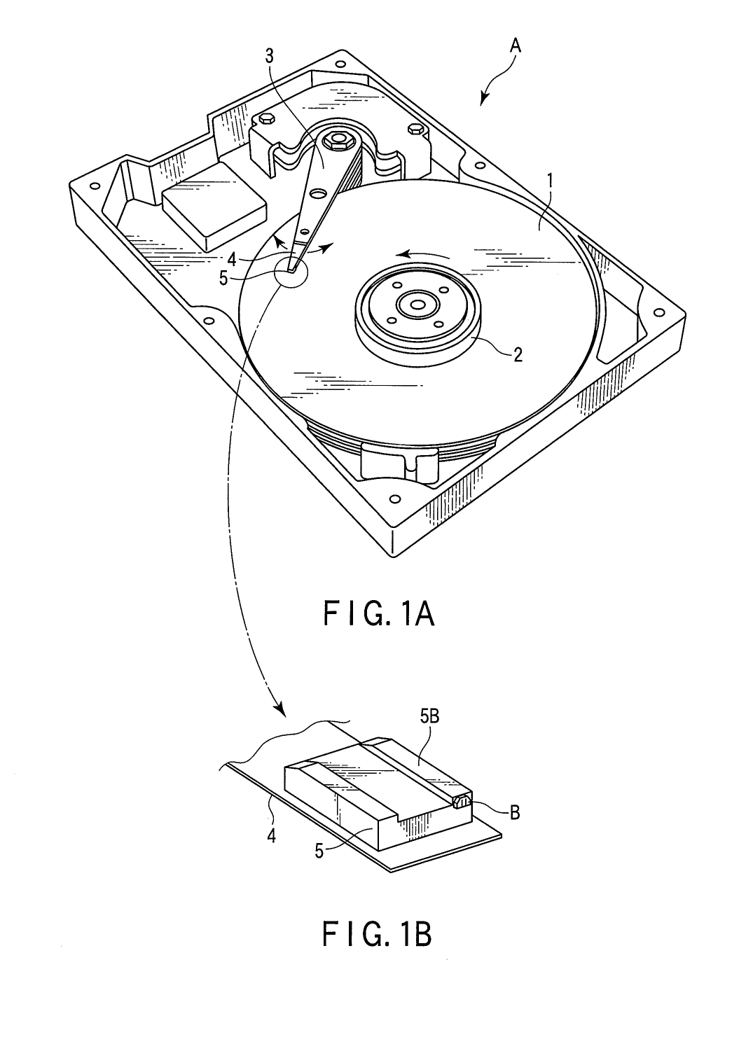

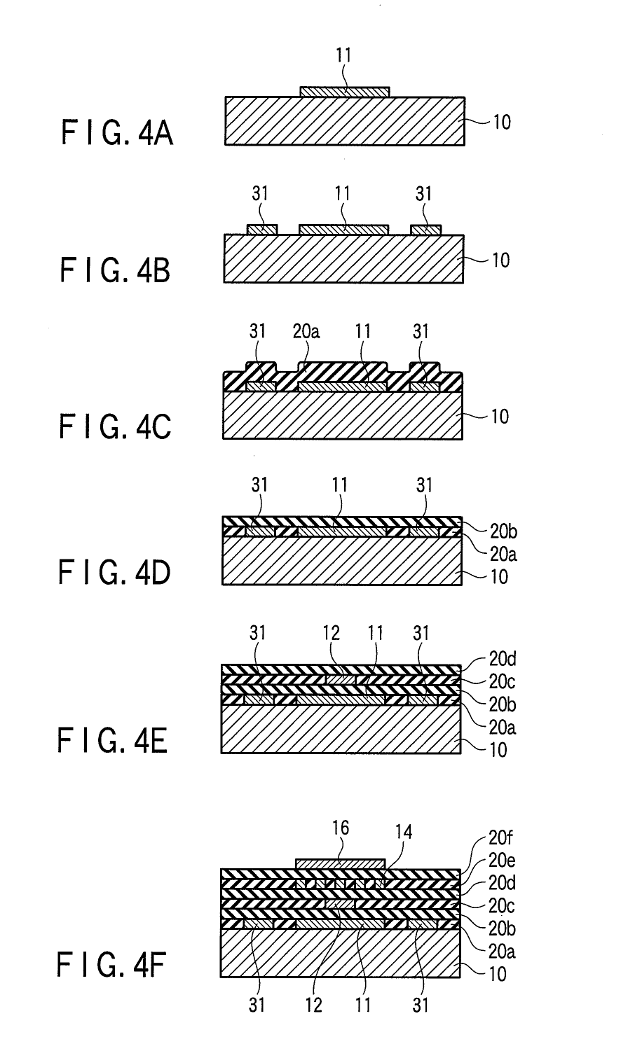

FIGS. 1A, 1B, 2, and 3 show a magnetic disk device and magnetic head according to a first embodiment, and FIGS. 4A, 4B, 4C, 4D, 4E, 4F, 5A, 5B, 5C, 5D, 5E, 6A, 6B, 6C, 6D, 7A, 7B, 7C, 7D, and 7E show an embodiment of a manufacturing method of the magnetic head.

As shown in FIGS. 1A and 1B, the magnetic disk device A is provided with a magnetic disk 1, spindle motor 2, and swing arm 3. The magnetic head B is provided on an end face 5A of a slider 5 supported on a distal end of a swing arm 3 through a suspension 4.

The slider 5 is arranged in a state where a floating surface 5B thereof is opposed to the surface of the magnetic disk 1, and a magnetic working surface B2 of the magnetic head B is formed in such a manner that the surface B2 is substantially flush with the floating surface 5B of the slider 5. When the magnetic disk 1 is rotated at high speed, an extremely thin air film is formed between the surface of the magnetic disk 1 and floating surface 5B of the slider 5. The magnetic head B is floated over the surface of the magnetic disk 1 at a flying height of, for example, about 10 to 15 nm through such an air film.

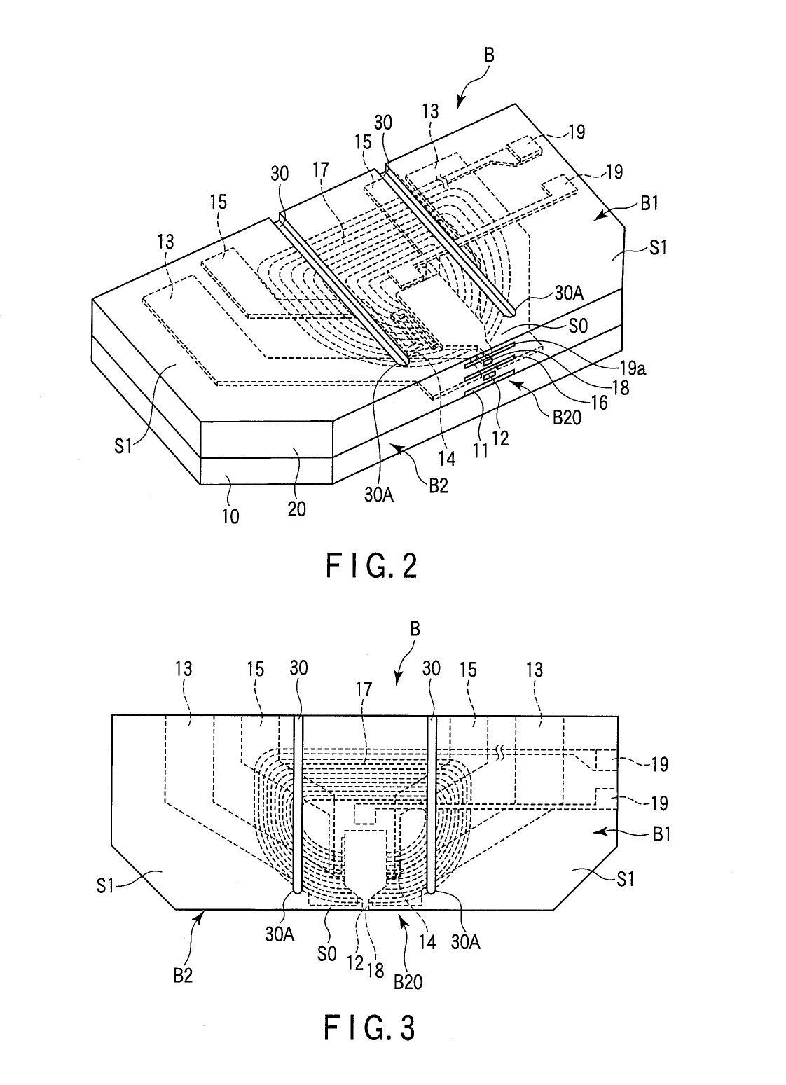

As shown in FIGS. 2 and 3, the magnetic head B comprises a substrate 10, first shield film 11, reproduction element (head element) 12, reproduction terminals 13, heating element 14, heating terminals 15, second shield film 16, recording coil 17, recording element (head element) 18, recording terminals 19, third shield film 19a, and insulating layer 20. A pair of grooves 30 is formed in an outer layer surface B1 of the magnetic head B, which is parallel with the end face 5A of the slider 5, and the reproduction element 12 and recording element 18 are exposed on the magnetic working surface B2 arranged along the floating surface 5B of the slider 5.

The substrate 10 is constituted of a sintered material of ceramic such as AlTiC, and is formed on the end face 5A of the slider by a semiconductor manufacturing process.

The first shield film 11 is configured to magnetically shield the reproduction element 12, and is formed on the substrate 10 to be opposed to the reproduction element 12.

The reproduction element 12 is a magneto-resistive effect element such as an MR or GMR, and is formed in such a manner that the element 12 is covered with the insulating layer 20 in a state where the element 12 is connected to the pair of reproduction terminals 13 on the first shield film 11. Such a reproduction element 12 is exposed on the magnetic working surface B2, and detects a magnetic field recorded on the magnetic disk 1 at a part thereof between points connected to the pair of reproduction terminals 13 to produce an electric signal.

The reproduction terminal 13 is configured to output the electric signal from the reproduction element 12 to the outside as a magnetic reproduction signal, and covered with the insulating layer 20 at a part between the reproduction element 12 and the second shield film 16. One end of the reproduction terminal 13 is connected to an end part of the reproduction element 12, and the other end thereof is exposed on the outer surface of the magnetic head B to be connected to a lead terminal (not shown).

The heating element 14 transmits heat to the peripheral area S0 of the reproduction element 12 and recording element 18 to thermally expand the peripheral area S0, thereby thermally protruding an element peripheral section B20 of the magnetic working surface B2 including the reproduction element and recording element 18 toward the magnetic disk 1. The heating element 14 is covered with the insulating layer 20 at a part between the reproduction terminal 13 and second shielding layer 16.

The pair of heating terminals 15 is configured to supply power to the heating element 14 to bring the section 14 into an electrified state, and is formed to be covered with the insulating layer 20 in the same layer as the heating element 14. One ends of the heating terminals 15 are connected to an end part of the heating element 14, and the other ends thereof are exposed on the outer surface of the magnetic head B to be connected to a lead terminal (not shown).

The second shield film 16 is configured to magnetically shield the reproduction element 12 and recording element 18 from each other, and is provided between the recording coil 17 and the layer in which the heating element 14 and heating terminals 15 are formed.

The recording coil 17 is configured to generate a recording magnetic field in the recording element 18, and covered with the insulating layer 20 at a part between the second shield film 16 and the recording element 18. One end of the recording coil 17 is connected to one recording terminal 19, and the other end thereof is connected to the other recording terminal 19.

The recording element 18 is a core magnetic pole for magnetic recording, and generates, when a current flows through the recording coil 17, a recording magnetic field corresponding to the magnitude and direction of the current between itself and the second shield film 16. The recording element 18 is covered with the insulating layer 20 at a part between the second shield film 16 and outer layer surface B1, and an end of the recording element is exposed on the magnetic working surface B2.

The recording terminals 19 are configured to supply a predetermined current to the recording coil 17 in accordance with a recording signal, and are covered with the insulating layer 20 in the same layer as the recording element 18. An end of the recording terminal 19 is connected to the recording coil 17, and the other end thereof is exposed on the outer surface of the magnetic head B to be connected to a lead terminal (not shown).

The third shield film 19a functions as a return magnetic pole for magnetic recording, and faces to the side of the recording element 18 opposite to the second shield film 16.

The insulating layer 20 is formed of, for example, alumina, and is formed to cover each section on the substrate 10.

The pair of grooves 30 is formed in the outer layer surface B1 in a depth of such a degree that the groove does not reach the recording element 18 and recording terminals 19, and extends in a longitudinal direction substantially perpendicular to the magnetic working surface B2 (thickness direction of the magnetic disk 1 and a direction in which the element peripheral section B20 is to protrude). These grooves 30 are configured to separate the peripheral area S0 including the reproduction element 12, recording element 18, and heating element 14, and outside areas S1 on both sides of the peripheral area S0 from each other. In each of the grooves 30 of this embodiment, one end part 30A thereof is stopped just short of the magnetic working surface B2 without reaching the surface B2, and the peripheral area S0 and outside areas S1 are continuous on the magnetic working surface B2 side. Such grooves 30 separate the peripheral area S0 from the outside areas S1, thereby playing a role of making the peripheral area S0 easy of deformation to a certain degree, concentrating the heat from the heating element 14 at the peripheral area S0, and making it hard for the heat to be transmitted to the outside areas S1. As a result of this, the peripheral area S0 is easily expanded by the heat from the heating element 14, and the element peripheral section B20 including the reproduction element 12 and recording element 18 exposed on the magnetic working surface B2 is largely protruded toward the magnetic disk 1 side.

The magnetic head including the grooves 30 is formed by the manufacturing method of the semiconductor manufacturing process to be described below. It should be noted that in this manufacturing method, the formation processes of the reproduction terminal 13, heating terminal 15, and recording terminal 19 are omitted, and the depth of the groove 30 is made to reach the layer of the first shield film 11.

First, as shown in FIG. 4A, the first shield film 11 is formed on the substrate 10. The first shield film 11 is formed by forming a resist layer on the substrate 10, thereafter forming a concave part in the resist layer by patterning and etching, filling the concave part with a material for the first shield film 11, and thereafter removing the resist layer. On the surface of the substrate 10 on which the first shield film 11 is to be formed, an insulating film (illustration thereof is omitted) of, for example, alumina is formed in advance.

Then, as shown in FIG. 4B, metallic patterns 31 used to form the grooves 30 are formed on both sides of the first shield film 11 on the substrate 10. Such metallic patterns 31 are formed by, for example, the following manufacturing processes.

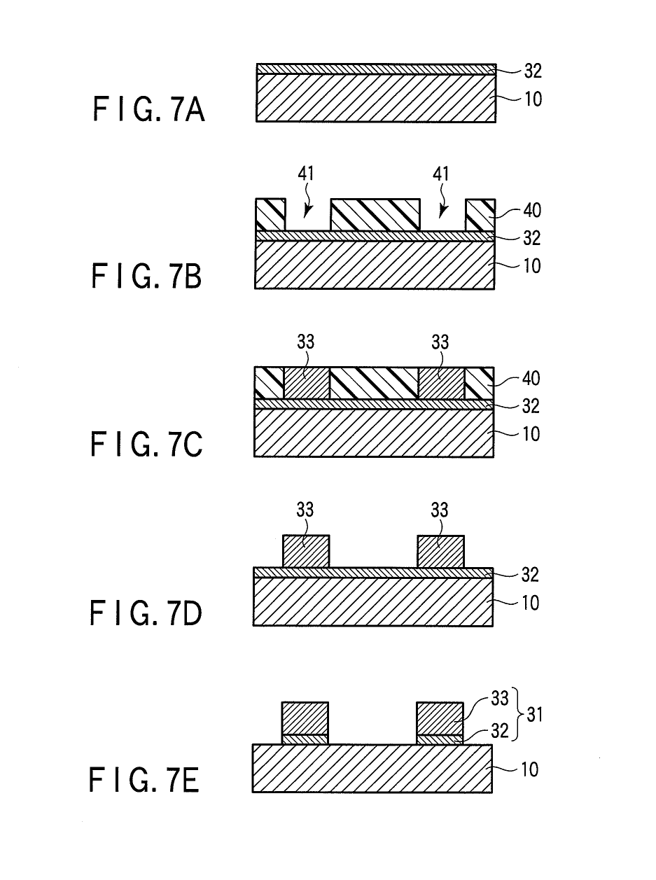

As shown in FIG. 7A, a metallic film 32 is formed by using, for example, copper on the substrate 10, thereafter forming a resist layer 40 on the top surface of the metallic film 32 as shown in FIG. 7B, and thereafter concave parts 41 are formed in the resist layer 40 by patterning and etching.

Then, as shown in FIG. 7C, metallic filling parts 33 are formed in the concave parts 41 of the resist layer 40 by growing the metallic film 32 by electroplating, and thereafter removing the resist layer 40 by dissolving the resist layer in an organic solvent as shown in FIG. 7D. As a result of this, the metallic filling parts 33 are exposed.

Then, as shown in FIG. 7E, surfaces of the metallic film 32, and metallic filling parts 33 are subjected to ion milling processing. As a result of this, part of the metallic film 32 is removed in a state where the metallic filling parts 33 are left, and the metallic patterns 31 shown in FIG. 4B are formed.

Thereafter, as shown in FIG. 4C, an insulating layer 20a is formed on the substrate 10 to cover the first shield film 11 and metallic patterns 31. Then, as shown in FIG. 4D, on the substrate 10, the insulating layer 20a is planarized to expose the first shield film 11 and metallic patterns 31, and thereafter an insulating layer 20b is formed again to cover the film 11 and patterns 31.

Then, as shown in FIG. 4E, by carrying out the same processes as those shown in FIGS. 4A to 4D, a reproduction element 12 and insulating layers 20c and 20d are formed on the insulating layer 20b. The reproduction element 12 is formed by forming a resist layer on the insulating layer 20b, thereafter forming a concave part in the resist layer by patterning and etching, filling the concave part with a magnetic material for the reproduction element 12, and thereafter removing the resist layer.

Then, as shown in FIG. 4F, by repetitively carrying out the same processes, the heating element 14, insulating layers 20e and 20f, and second shield film 16 are formed on the insulating layer 20d.

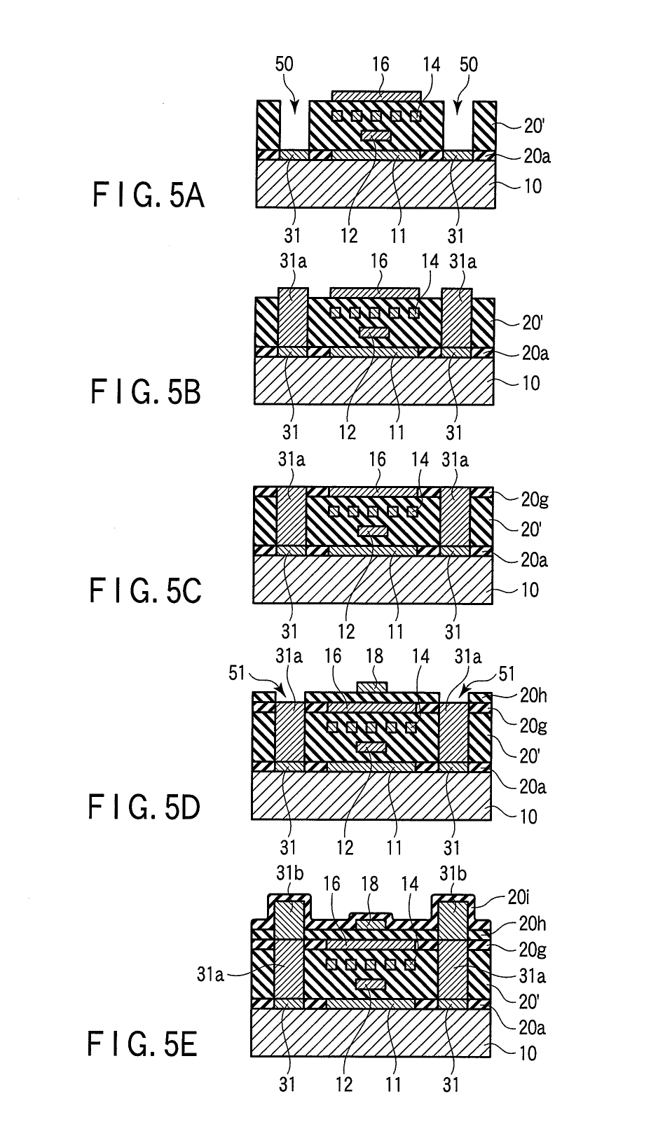

Then, as shown in FIG. 5A, through-holes 50 are formed at parts corresponding to the metallic patterns 31 in the insulating layer 20′ (insulating layers 20b to 20f) by, for example, etching using a mask pattern or ion milling processing. Then, as shown in FIG. 5B, the same processes as those shown in FIGS. 7C to 7E are carried out in the through-holes 50, whereby the metallic patterns 31a are formed.

Then, as shown in FIG. 5C, on the insulating layer 20′, an insulating layer 20g is formed to cover the metallic patterns 31a and second shield film 16, thereafter the insulating layer 20g is planarized to expose the second shield film 16 and metallic patterns 31a.

Then, as shown in FIG. 5D, by carrying out the same processes as those shown in FIGS. 4E, 4F, and 5A on the insulating layer 20g, an insulating layer 20h and recording element 18 are formed, and thereafter through-holes 51 are formed at parts corresponding to the metallic patterns 31a.

Then, as shown in FIG. 5E, by carrying out the same processes as those shown in FIGS. 7C to 7E in the through-holes 51, metallic patterns 31b are formed, and thereafter, on the insulating layer 20h, an insulating layer 20i is formed to cover the metallic patterns 31b and recording element 18.

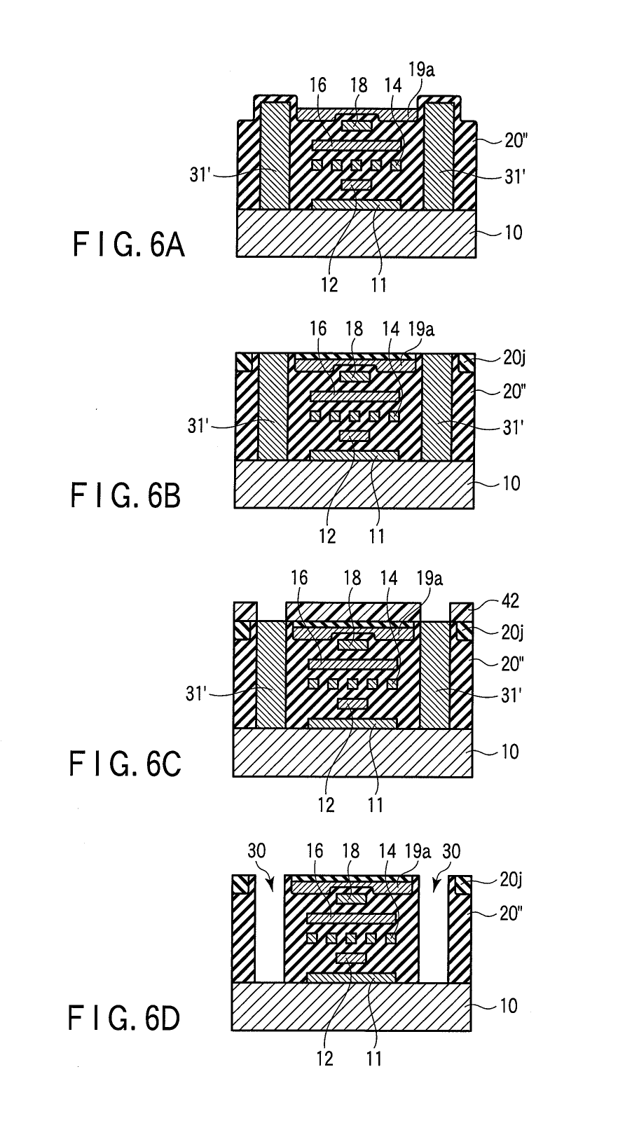

Then, as shown in FIG. 6A, a third shield film 19a is formed on the surface part of the insulating layer 20″ (insulating layers 20a, 20′, 20g, and 20i) corresponding to the recording element 18. Then, as shown in FIG. 6B, on the insulating layer 20″, an insulating layer 20j is formed to cover the third shield film 19a, and thereafter the insulating layer 20j is planarized to expose the metallic patterns 31′ (metallic patterns 31, 31a, and 31b).

Then, as shown in FIG. 6C, on the insulating layer 20j, a mask pattern layer 42 is formed to cover parts other than parts corresponding to the metallic patterns 31′.

Finally, as shown in FIG. 6D, the metallic patterns 31′ are removed by dissolving the patterns 31′ in an acid through the mask pattern layer 42, and thereafter the mask pattern layer 42 is removed by dissolving the layer 42 in an organic solvent. As a result of the above, the pair of grooves 30 is so formed as to allow it to reach the layer of the first shield film 11, whereby a magnetic head in which the depth of the grooves 30 is larger than that shown in FIG. 2 is obtained.

The magnetic head configured and formed in the manner described above has the following functions.

On the surface of the magnetic disk 1 rotating at high speed, the slider 5 flies by an air film. As a result of this, the magnetic head B provided on the end face 5A of the slider 5 is also floated over the surface of the magnetic disk 1, and the flying height thereof is a distance from the surface of the magnetic disk 1 to the magnetic working surface B2, this being, for example, about 10 to 15 nm.

When the heating element 14 generates heat in the magnetic head B floated in this manner, the heat from the heating element 14 is transmitted to the peripheral area S0, and the element peripheral section B20 of the magnetic working surface B2 including the reproduction element 12 and recording element 18 protrudes toward the magnetic disk 1 side by an amount larger than the outside areas S1. The degree of protrusion thereof is, for example, about several nm. As a result of this, the flying height of the magnetic head B becomes substantially smaller by the amount corresponding to the degree of protrusion of the element peripheral section B20. Such reduction in the flying height of the magnetic head B reduces the reproduction error or recording error to the utmost, leading to higher recording density.

When the element peripheral section B20 is thermally protruded, the structure is so made as to allow the peripheral area S0 to be separated from the outside areas S1, and hence even when the calorific value of the heating element 14 is not so large, heat is liable to be concentrated at the peripheral area S0, and it becomes easy for the element peripheral section B20 to locally effect thermal expansion and protrusion. As a result of this, it is possible to cause the element peripheral section B20 to quickly effect the desired degree of protrusion by as small a calorific value as possible.

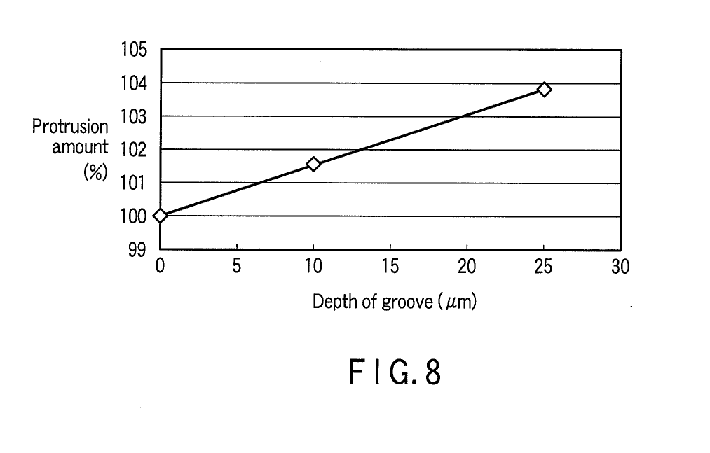

It is evident that the degree of protrusion of the element peripheral section B20 is increased by forming the pair of grooves 30 from the simulation result shown in FIG. 8.

As shown in FIG. 8, in the simulation, regarding the degree of protrusion of the element peripheral section for the depth of the grooves 30, the longitudinal dimension of the outer layer surface was set at, for example, 30 μm, the depth of the grooves 30 was set at 0 to 25 μm, and thermal analysis by the finite element method was tried. As a result of this, the simulation result shown in FIG. 8 was obtained. That is, assuming the degree of protrusion of a case where the grooves are not formed (depth of the grooves is zero) to be 100%, in the case where grooves 30 of a depth of 10 μm were formed, the degree of protrusion became larger by about 1.5%, and in the case where grooves 30 of a depth of 25 μm were formed, the degree of protrusion became larger by about 4%. According to the above result, it is evident that the degree of protrusion of the element peripheral section S0 becomes larger by making the depth of the grooves 30 as deep as possible.

Therefore, according to the magnetic head B of this embodiment, the heat transmitted from the heating element 14 to the peripheral area S0 is blocked by the pair of grooves 30, the heat is concentrated at the peripheral area S0, and is hardly transmitted to the outside areas S1. As a result of this, the element peripheral section B20 of the magnetic working surface B2 included in the peripheral area S0 easily and locally effects thermal expansion, and hence it is possible to make the degree of protrusion of the element peripheral section B20 including the reproduction element 12 and recording element 18 by as small a calorific value as possible.

According to the manufacturing method of the magnetic head B of this embodiment, it is possible to collectively form grooves 30 of a large number of magnetic heads B, and efficiently form the grooves 30 by carrying out the semiconductor manufacturing process before dividing a substrate 10 into magnetic head units.

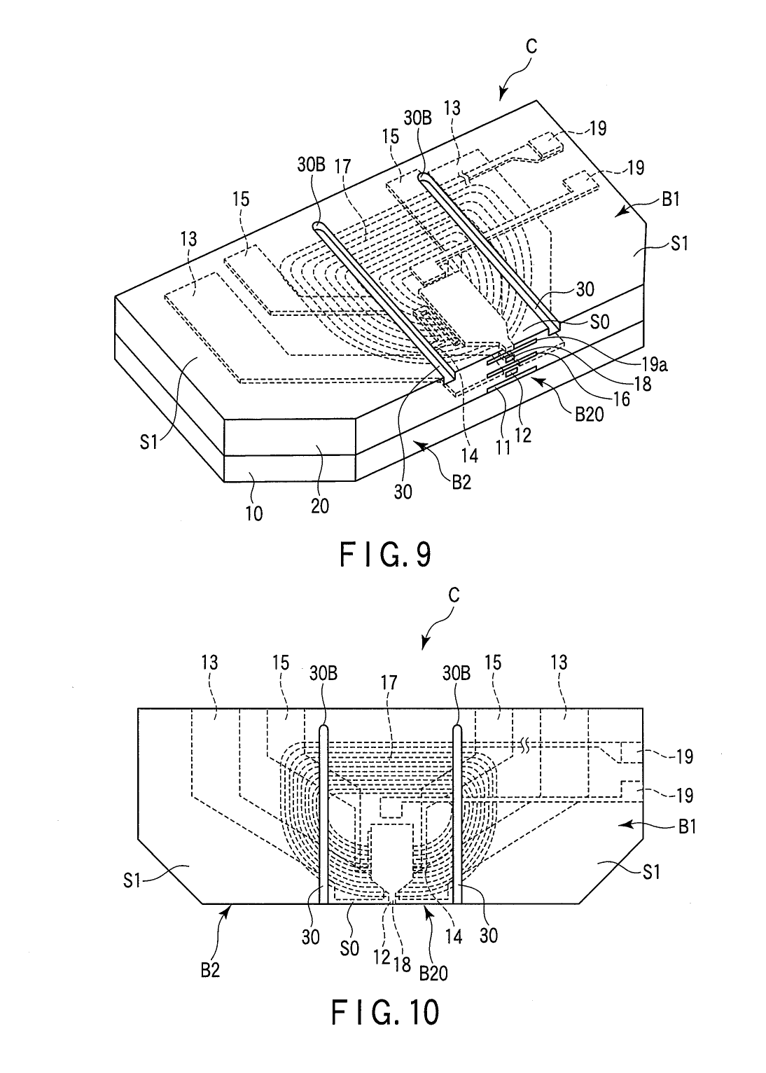

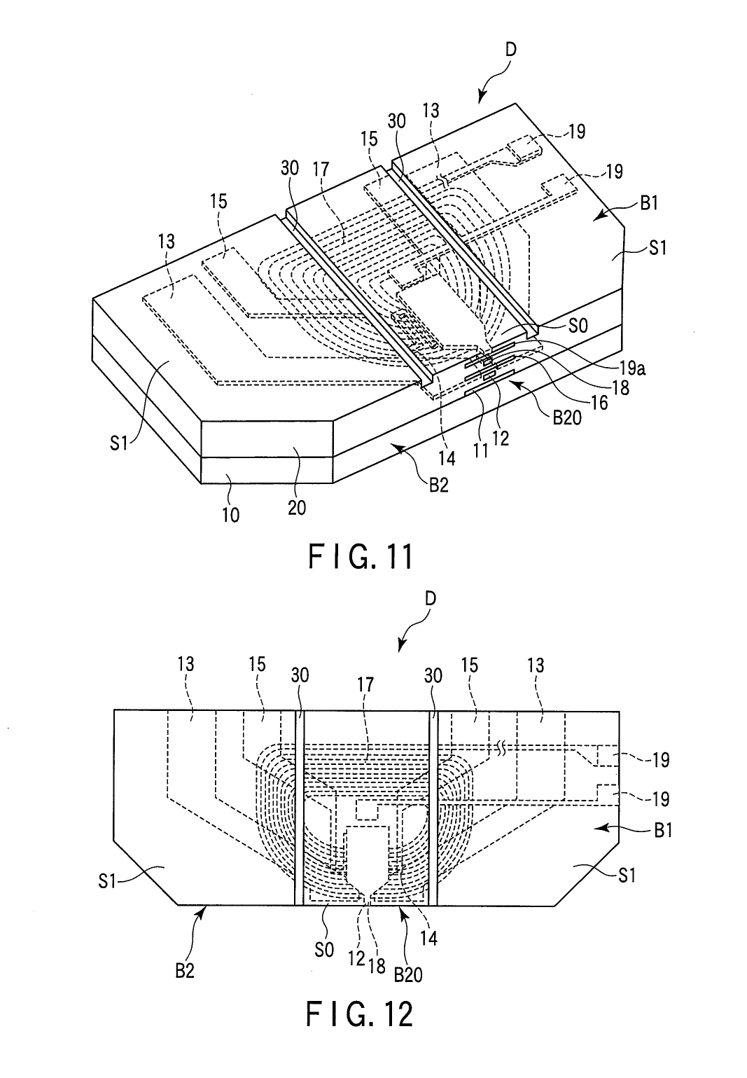

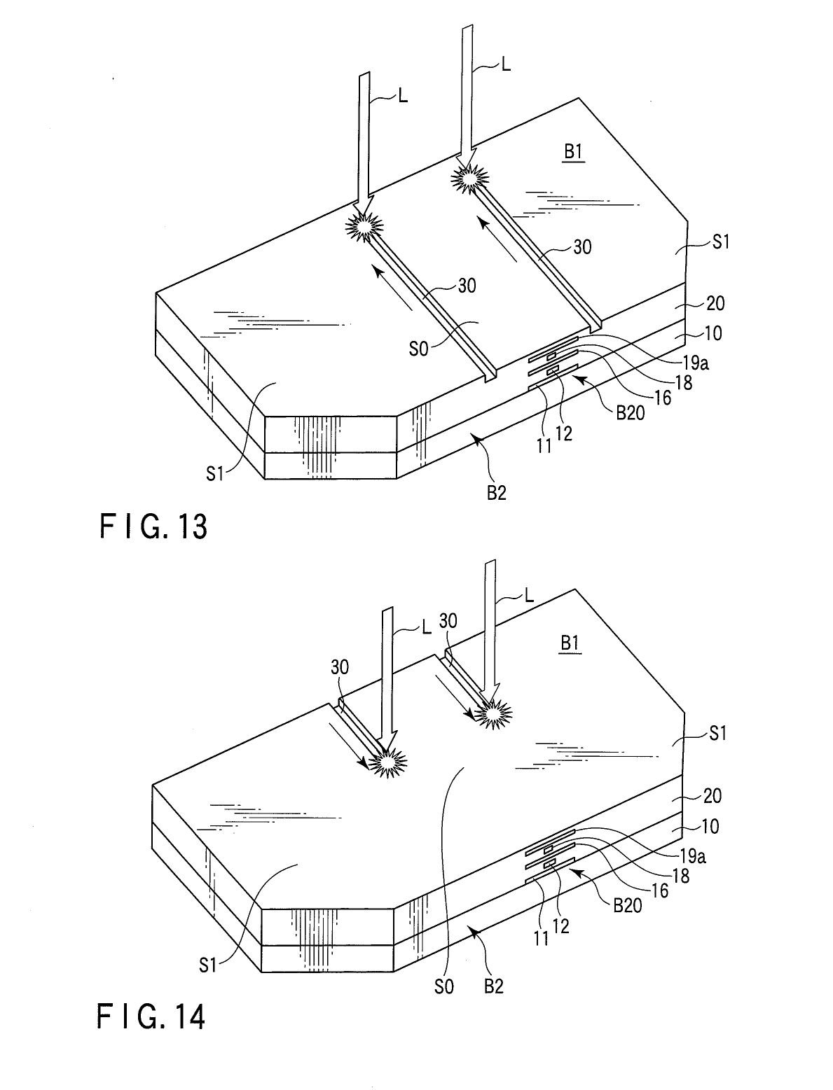

Next, another embodiment of the present invention will be described. FIGS. 9 and 10 show a magnetic head according to a second embodiment, and FIG. 13 shows a method of manufacturing the magnetic head according to the second embodiment. FIGS. 11 and 12 show a magnetic head according to a third embodiment, and FIG. 14 shows a method of manufacturing the magnetic head according to the third embodiment. It should be noted that constituent elements identical with or similar to those of the first embodiment are denoted by the reference symbols identical with those of the first embodiment, and a description of them is omitted.

As shown in FIGS. 9 and 10, in the magnetic head C according to the second embodiment, a pair of grooves 30 on an outer layer surface B1 is formed to pass through a magnetic working surface B2, and one end part 30B of each groove 30 is formed in the vicinity of an outer surface (reference symbol thereof is omitted) on the opposite side of the magnetic working surface B2. That is, a peripheral area S0 and outside areas S1 are separated from each other on the magnetic working surface B2 side. According to such grooves 30, an element peripheral section B20 of the magnetic working surface B2 is securely separated from the outside areas S1, and hence it is possible to make such an element peripheral section B20 a part which is liable to be thermally deformed, and it is further possible to make a degree of protrusion of the element peripheral section B20 larger by thermal expansion.

The pair of grooves 30 shown in FIGS. 9 and 10 can be formed by removal processing using a laser beam L as shown in FIG. 13.

When the removal processing using the laser beam L is carried out, the laminated structure from the substrate 10 to the outer layer surface B1 is formed on the end face 5A of a slider 5 by the same semiconductor manufacturing process as the previously described embodiment, thereafter the outer layer surface B1 is irradiated with, for example, the laser beam L, and the pair of grooves 30 is formed by the removal processing by using the laser beam L.

At this time, the laser beam L starts the removal processing from the magnetic working surface B2, is gradually moved away from the magnetic working surface B2, and is stopped immediately before reaching the outer surface on the opposite side of the magnetic working surface B2. As a result of this, an element peripheral section B20 separated from the outside areas S1 by the pair of grooves 30 is formed on the magnetic working surface B2, and it becomes easy for the element peripheral section B20 to be deformed with respect to the outside areas S1. Since the laser beam L is started to be moved from the edge end of the magnetic working surface B2, a processing mark due to the laser processing is hardly caused on the magnetic working surface B2, and hence no such a magnetic working surface B2 as to adversely affect the floating of the magnetic head B is formed.

In the manufacturing method using such a laser beam L, it is possible to monitor the degree of protrusion of the element peripheral section B20 by means of, for example, an imaging device in a state where the heating element 14 is made to generate heat while moving the laser beam L at a predetermined rate. As a result of this, it is possible to stop the moving of the laser beam at a time at which the degree of protrusion of the element peripheral section B20 has reached the desired amount, whereby it is possible to adjust the length of the grooves 30, and prevent the degrees of protrusion of the individual magnetic heads C from diverging from each other.

As shown in FIGS. 11 and 12, in a magnetic head D according to a third embodiment, a pair of grooves 30 is formed to pass through a part from an end part on the magnetic working surface B2 side of an outer layer surface B1 to an end part on the opposite side. That is, a peripheral area S0 and outside areas S1 are completely separated from each other on the outer layer surface B1. According to such grooves 30, the degree of freedom of deformation of the peripheral area S0 is enhanced, and the element peripheral section B20 becomes more deformable, whereby it is possible to make the degree of protrusion of the element peripheral section B20 much larger.

The pair of grooves 30 shown in FIG. 11 can also be formed by removal processing using laser beam L as shown in FIG. 14.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the outer layer surface of the magnetic head, a groove parallel with the magnetic working surface may be formed between the pair of grooves to connect the grooves to each other. As for the manufacturing method of the groove, a groove shown in FIGS. 9 and 11 may be formed by the removal processing of the semiconductor manufacturing processes shown in FIGS. 4A to 7E.

What is claimed is:

1. A magnetic head comprising:
a head element configured to record or reproduce;
a heating element configured to thermally protrude the head element; and
a groove configured to partition a peripheral area of the head element in a direction the head element protrudes.

2. The magnetic head of claim 1, wherein
the groove comprises a terminal part in close proximity to a magnetic working surface of the head element and not configured to pass through the magnetic working surface.

3. The magnetic head of claim 1, wherein
the groove comprises a terminal part configured to pass through the magnetic working surface of the head element.

4. The magnetic head of claim 1, comprising a pair of grooves on both sides of the peripheral area of the head element to partition the peripheral area in a direction the head element protrudes.

5. A magnetic disk device comprising:
a magnetic disk;
a slider opposite to the magnetic disk; and
a magnetic head on the slider, and comprising a head element configured to record or reproduce, an heating element configured to thermally protrude the head element to make the head element closer to a surface of the magnetic disk, and a groove configured to partition a peripheral area of the head element in a direction the head element protrudes.

6. The magnetic disk device of claim 5, wherein
the groove comprises a terminal part in close proximity to a magnetic working surface of the head element and configured to not pass through the magnetic working surface.

7. The magnetic disk device of claim 5, wherein
the groove comprises a terminal part configured to pass through the magnetic working surface of the head element.

8. The magnetic disk device of claim 5, comprising a pair of grooves on both sides of the peripheral area of the head element to partition the peripheral area in a direction the head element protrudes.

9. A method of manufacturing a magnetic head comprising:
forming, on a slider, a reproduction element configured to read, a recording element configured to record, and a heating element configured to heat a peripheral area of the reproduction element and recording element; and
forming grooves configured to partition the peripheral area.

10. The method of claim 9, wherein
forming grooves comprises removal processing towards a magnetic working surface of the magnetic head, and stopping the removal processing in close proximity to the magnetic working surface.

11. The method of claim 9, wherein
forming the grooves comprises removal processing started from the magnetic working surface of the magnetic head.

12. The method of claim 9, wherein
forming the grooves comprises forming while heating the heating element and monitoring a degree of protrusion of the reproduction element and recording element, and stopping the formation of the groove at when the degree of protrusion reaches a predetermined value.
